(19) United States
(12) Patent Application Publication
(10) Pub. No.: US 2025/0115716 A1
(43) Pub. Date: Apr. 10, 2025

(54) POLY(TETRAMETHYLENE OXIDE)-BASED SEGMENTED IONENES BLOCK COPOLYMERS WITH ALIPHATIC OR DABCO HARD SEGMENTS

(71) Applicants: Matthew Green, Phoenix, AZ (US); Jae Sang Lee, Tempe, AZ (US)

(72) Inventors: Matthew Green, Phoenix, AZ (US); Jae Sang Lee, Tempe, AZ (US)

(21) Appl. No.: 18/904,936

(22) Filed: Oct. 2, 2024

Related U.S. Application Data
(60) Provisional application No. 63/588,545, filed on Oct. 6, 2023.

(51) Int. Cl. C08G 73/02

(52) U.S. Cl. CPC C08G 73/0273; C08G 73/024

(57) ABSTRACT

Synthesizing an ionene polymer includes combining a soft segment, a hard segment, and a solvent to yield a mixture, and heating the mixture to yield the ionene polymer. The soft segment includes bromine end-capped poly(tetramethylene oxide (Br-PTMOₙ-Br), and the hard segment comprises a linear aliphatic compound or 1,4-diazabicyclo[2.2.2]octane (DABCO).

### CROSS-REFERENCE TO RELATED APPLICATION

This application claims the benefit of U.S. Patent Application No. 63/588,545 filed on Oct. 6, 2023, which is incorporated herein by reference in its entirety.

### STATEMENT OF GOVERNMENT INTEREST

This invention was made with government support under W911NF-18-1-0412 awarded by the Army Research Office. The government has certain rights in the invention.

### TECHNICAL FIELD

This invention relates to ionene block copolymers with hard and soft segments in the polymer backbone.

### BACKGROUND

Ammonium ionenes contain quaternary nitrogen atoms in their backbone chain. lonenes have been prepared via the Menshutkin reaction, a reaction of tertiary amine with a halide, and the polymerization typically proceeds via an S_{N}2 mechanism. Ionenes include non-segmented and segmented ionenes. Segmented ionenes have relatively soft and hard segments along the backbone, and the soft segments are relatively long oligomeric monomers, whereas hard segments are usually short-length monomers. Segmented ionenes show elastomeric behavior similar to polyurethane (PU) elastomers, and possess non-covalent physical crosslinks caused by ionic interaction or aggregation.

### SUMMARY

This disclosure describes poly(tetramethylene oxide) (PTMO)-based segmented ionenes in which the ionenes have linear aliphatic or 1,4-diazabicyclo[2.2.2]octane (DABCO) hard segments. Both linear aliphatic and DABCO-based ionenes have Br⁻ counterions and different (e.g., four different) soft segment contents.

In a general aspect, synthesizing an ionene polymer includes combining a soft segment, a hard segment, and a solvent to yield a mixture, and heating the mixture to yield the ionene polymer, wherein the soft segment comprises bromine end-capped PTMOₙ (Br-PTMOₙ-Br), and the hard segment comprises a linear aliphatic compound or 1,4-diazabicyclo[2.2.2]octane (DABCO).

This disclosure also describes the effects of the contents of the soft and hard segments as well as the type of hard segments (linear aliphatic and DABCO) on the properties of poly(tetramethylene oxide) (PTMO)-based segmented ionenes. Soft segment weight fractions up to 75 wt % induce heterogeneous crystallization while the melting temperature decreases due to the lower degree of crystallization. The formation of a higher degree of ionic aggregates is observed in both linear aliphatic and DABCO-based PTMO ionenes with 25 wt % of soft segment resulting from strong Coulombic interactions between hard segments. DABCO-based ionenes show a higher degree of phase separation compared to linear aliphatic analogs and display a long-range ordered lamellar structure. In contrast, linear aliphatic ionenes show the formation of random ionic domains. The PTMO-based ionenes are thermally stable up to 250° C., suggesting that the DABCO hard segment has a weaker protective effect against the degradation of the PTMO soft segment at elevated temperatures compared to the linear aliphatic hard segment. Uniaxial tensile tests exhibit stress-induced crystallization of PTMO-based ionenes, high elongation at break with linear aliphatic hard segment compared to the DABCO hard segment, and the opposite trend of Young's modulus and ultimate tensile strength by changing the type of the hard segment.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 shows the nomenclature of synthesized segmented ionenes.

FIG. 2A depicts the synthesis of Br-PTMOn-Br. FIG. 2B depicts synthesis of linear aliphatic PTMOXX/DD-ionenes or DABCO-based PTMOXX/DD-ionenes. XX refers to 25, 50, or 75, which corresponds to the overall weight fraction of the PTMO soft segment.

FIGS. 3A and 3B show DSC results of linear aliphatic and DABCO-based PTMO ionenes, respectively. FIGS. 3C and 3D show melting temperature and degree of crystallization determined by DSC by dividing the value of melting enthalpy by the weight fraction of PTMO soft segment of linear aliphatic and DABCO-based PTMO ionenes. The weight (%) on the x-axis corresponds to the weight fraction of PTMO soft segments.

FIGS. 4A and 4B show overlayed XRD diffraction of linear aliphatic PTMO ionenes and DABCO-based PTMO ionenes, respectively. FIGS. 4C and 4D show schematics of characteristic length scale of linear aliphatic PTMO ionenes and DABCO-based PTMO ionenes, respectively, where dx=2π/qx and x is PTMO soft segment(s), ionic (i), or dodecane (d).

FIGS. 5A and 5B show overlayed TGA curves (solid lines) and derivative weight loss curves (dashed lines) for linear aliphatic PTMO ionenes and DABCO-based PTMO ionenes, respectively.

FIGS. 6A and 6B show overlayed DMA results of linear aliphatic PTMO ionenes and DABCO-based PTMO ionenes, respectively.

FIGS. 7A and 7B show SAXS intensity as a function of scattering vector (q) of linear aliphatic PTMO ionenes and DABCO-based PTMO ionenes, respectively.

FIGS. 8A-8E depict the proposed morphology of linear aliphatic PTMOXX/DD-ionenes, linear aliphatic PTMO93-ionene, DABCO-based PTMO25/DD-ionene, DABCO-based PTMO50 and 75/DD-ionenes, and DABCO-based PTMO95-ionene, respectively, according to X-ray scattering results. Dark and light circular dots represent ion aggregates connected with and without dodecane, respectively.

FIGS. 9A and 9B show tensile tests of linear aliphatic PTMO ionenes and DABCO-based PTMO ionenes, respectively, at room temperature. The stress-strain curves shown are representative examples of replicate experiments.

### DETAILED DESCRIPTION

This disclosure describes the synthesis of poly(tetramethylene oxide) (PTMO)-based segmented ionenes with two structurally different hard segments and four different soft/hard segment contents via the Menshutkin reaction. All PTMO-based ionenes were thermally stable up to 250° C. According to differential scanning calorimetry (DSC) results, the melting temperature gradually decreased with increasing the content of soft segments up to 75 wt % due to the decrease of the degree of crystallization. All PTMO-based ionenes displayed microphase separation regardless of the type of hard segments. DABCO-based PTMO ionenes induced a higher degree of phase separation compared to linear aliphatic analogs. Higher content of hard segment showed a better elastomeric behavior by having a higher rubbery plateau storage modulus and wider rubber plateau due to the strong ionic aggregation. X-ray diffraction (XRD) and small-angle X-ray scattering (SAXS) revealed the spherical ionic aggregation in the linear aliphatic ionenes, whereas DABCO-based ionenes over 25 wt % of the soft segment exhibited an ordered lamellar structure, which was confirmed by atomic force microscopy (AFM). The uniaxial tensile tests showed that the stress-induced crystallization occurred with higher contents of PTMO soft segment over 50 wt %, which prevents further elongation. PTMO-based ionenes with the linear aliphatic hard segment showed a better elongation compared to DABCO-based ionenes at room temperature.

As described herein, synthesizing an ionene polymer includes combining a soft segment, a hard segment, and a solvent to yield a mixture, and heating the mixture to yield the ionene polymer. The soft segment is a bromine end-capped PTMOₙ (Br-PTMOₙ-Br, where n is an integer selected such that a molecular weight of the Br-PTMOₙ-Br is in a range of 200-8000 Da), and the hard segment is a linear aliphatic compound or 1,4-diazabicyclo[2.2.2]octane (DABCO). A molar ratio of the soft segment to the hard segment is in a range of about 0.95-1.05 (e.g., about 1).

In some implementations, the hard segment is a linear aliphatic compound (e.g., tetramethyl-1,6-hexanediamine). The solvent is a polar organic solvent. In some cases, the solvent is an alcohol, such as methanol. Other suitable solvents include N-methyl-2-pyrrolidone, dimethylglyoxime, dimethylacetamide, ethanol, acetone, and dimethyl sulfoxide. The resulting ionene polymer is represented by:

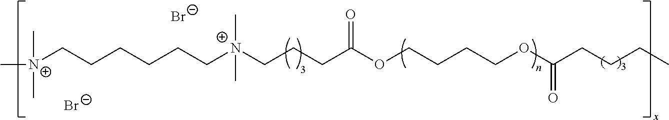

where n and x are integers (e.g., n=1 to 140, x=1 to 200). In some cases, n and x are independently selected such that the molecular weight of the polymer is about 20,000-50,000 Da.

In some implementations, the hard segment is DABCO. The solvent is dimethylformamide. The ionene polymer is represented by:

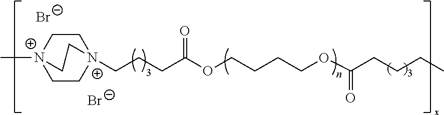

where n and x are integers (e.g., n=1 to 140, x=1 to 200). In some cases, n and x are independently selected such that the molecular weight of the polymer is about 20,000-50,000 Da.

In some implementations, the hard segment includes an additional linear aliphatic compound. In one example, the additional linear aliphatic compound is 1,12-dibromododecane. The weight fraction of the soft segment to the total amount of the soft segment and the hard segment is in a range between 0.1 and 0.9 or between 0.25 and 0.75.

The hard segment can include the linear aliphatic compound and the additional linear aliphatic compound. When the linear aliphatic compound is tetramethyl-1,6-hexanediamine and the solvent is methanol, the ionene polymer is represented by:

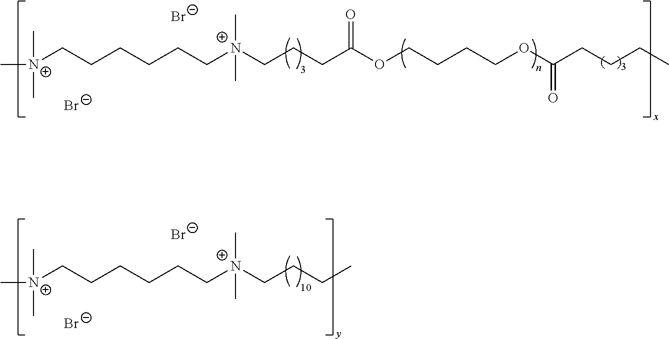

where n, x, and y are integers (e.g., n=1 to 140, x=1 to 200, y=1 to 200).

The hard segment can include DABCO. When the hard segment is DABCO and the additional linear aliphatic compound, and the solvent includes dimethylformamide and dimethyl sulfoxide, the ionene polymer is represented by:

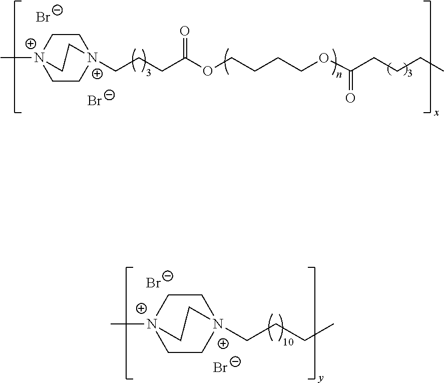

where n, x, and y are integers (e.g., n=1 to 140, x=1 to 200, y=1 to 200).

### EXAMPLES

Poly(tetrahydrofuran) (PTMO) 2000 g mol⁻¹, N,N,N′,N′-tetramethyl-1,6-hexanediamine (99%), triethylamine (≥99.5%), 6-bromohexanoyl chloride (97%), 1,4-diazabicyclo[2.2.2]octane (DABCO) (≥99%), and dimethyl sulfoxide (DMSO) (≥99.9%) were purchased from Sigma Aldrich. Chloroform-d, and dimethyl sulfoxide-d₆ were purchased from Alfa Acsar. Dichloromethane (DCM), dimethylformamide (DMF), and methanol (MeOH) were purchased from VWR Chemicals. 1,12-dibromodedecane was obtained from TCI America. All materials were used as received except 1,12-dibromododecane (≥98%), which was recrystallized in isopropyl alcohol.

Br-PTMOn-Br was prepared by methods generally known in the art. PTMO-2k (7 g, 1 eq) was dissolved in DCM (50 mL), and triethylamine (0.7893 g, 2.2 eq) was added in a round bottom flask. 6-bromohexanoyl chloride (1.6653 g, 2.2 eq) was added dropwise at 0° C. (ice bath) and slowly heated to room temperature and stirred for 1 d. Then the salt was filtered four times, and the organic phase was washed with a saturated sodium bicarbonate solution five times. The organic phase solution was dried in the vacuum oven at 40° C. for 1 d.

Aliphatic and DABCO-based PTMO-ionenes are synthesized with Br-PTMOₙ-Br and N,N,N′,N′-tetramethyl-1,6-hexanediamine or DABCO in MeOH or DMF, respectively, and stirred at 75° C. for 3 d. The molar ratio of Br-PTMOₙ-Br to N,N,N′, N′-tetramethyl-1,6-hexanediamine or DABCO was equal to one. The synthesized ionenes were dried at room temperature for 1 d followed by drying at 60° C. for 1 d, and at room temperature under vacuum for 1 d.

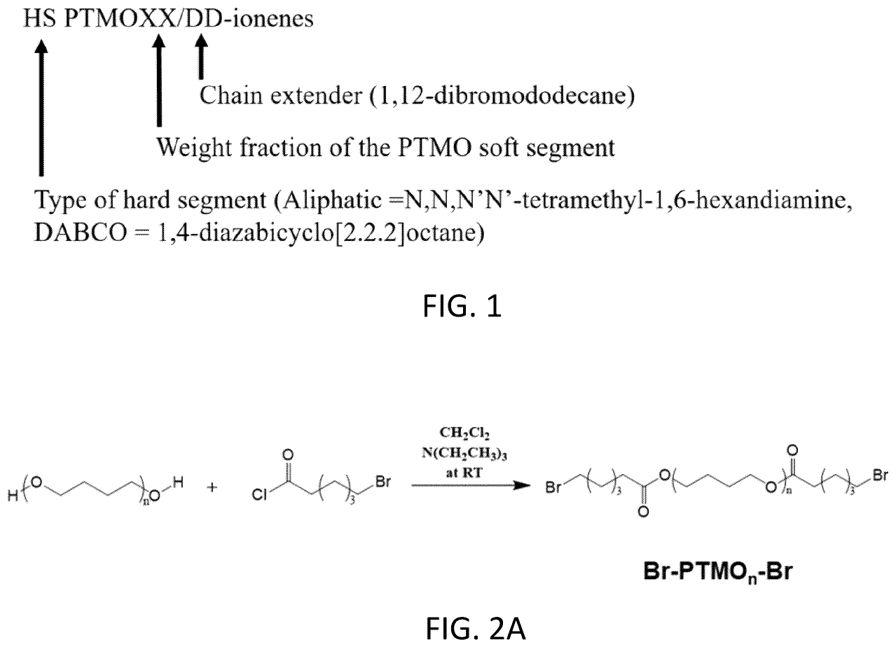

Three different weight fractions of PTMO soft segment, 25, 50, and 75 wt %, and counterparts of hard segments were synthesized with Br-PTMOₙ-Br, 1,12-dibromododecane, and N,N,N′,N′-tetramethyl-1,6-hexanediamine or DABCO. The molar ratio of Br-PTMOn-Br to the sum of 1,12-dibromododecane and N,N,N′,N′-tetramethyl-1,6-hexanediamine or DABCO was equal to one, as shown in Table 1. For example, the aliphatic PTMO50/DD-ionenes, which has 50 wt % of PTMO soft segment and 50 wt % of hard segments, Br-PTMOₙ-Br (1 g), 1,12-dibromododecane (0.608 g), and N,N,N′,N′-tetramethyl-1,6-hexanediamine (0.392 g) was added in MeOH and stirred at 75° C. for 3 d with the condenser connected. The concentration of all series of linear aliphatic ionenes was 2 mol/L. The synthesized ionenes were dried at room temperature for 1 d, followed by drying at 60° C. for 1 d and at room temperature under vacuum for 1 d. The mixture of DMF and DMSO solvents was used for DABCO-based ionenes and stirred at 75° C. for 5 d. The synthesized ionenes were dried at 80° C. under vacuum for 1 d. Then, DABCO-based ionenes were re-casted by dissolving in DMSO. They were dried at room temperature for 4 d to prevent the defect of film, followed by drying at 80° C. in the oven for 2 d and an additional 1 d at room temperature under vacuum. The nomenclature of synthesized segmented ionenes, shown in FIG. 1A, provides information on the type of hard segment and contents of the soft segments. Samples were transported directly from the oven to the equipment used for characterization below to avoid water uptake from the ambient air.

Table 1. Compositions of linear aliphatic and DABCO-based PTMO-ionenes. DD and AM refer to 1,12-dibromododecane and N,N,N′N′-tetramethyl-1,6-hexandiamine or DABCO, respectively.

| | | Soft | Hard segment, | |
|---|---|---|---|---|
| | Molar ratio | segment, | wt % | |
| Sample | PTMO/DD/AM | wt % | DD | AM |
| Aliphatic PTMO25/DD- | 1.0/13.7/14.7 | 25 | 53 | 22 |
| ionenes | | | | |
| Aliphatic PTMO50/DD- | 1.0/4.4/5.4 | 50 | 30.4 | 19.6 |
| ionenes | | | | |
| Aliphatic PTMO75/DD- | 1.0/1.2/2.2 | 75 | 12.8 | 12.2 |
| ionenes | | | | |
| Aliphatic PTMO93- | 1.0/0/1.0 | 93 | 0 | 7 |
| ionenes | | | | |
| DABCO-based PTMO25/ | 1.0/15.8/16.8 | 25 | 55 | 20 |
| DD-ionenes | | | | |
| DABCO-based PTMO50/ | 1.0/5.1/6.1 | 50 | 35.5 | 14.5 |
| DD-ionenes | | | | |
| DABCO-based PTMO75/ | 1.0/1.5/2.5 | 75 | 15.9 | 9.1 |
| DD-ionenes | | | | |
| DABCO-based PTMO95- | 1.0/0/1.0 | 95 | 0 | 5 |
| ionenes | | | | |

¹H NMR spectroscopic analyses were performed on Bruker Avance III 500 MHz NMR. Chloroform-d and DMSO-d₆ were used for linear aliphatic and DABCO-based ionenes, respectively. DSC was performed on a TA Instruments Q2000. The sample was heated from 40° C. to 160° C., cooled down to −80° C., and then heated up to 160° C. The purge gas was ultra-high purity (UHP) nitrogen with a gas flow rate of 25 mL/min. The heating and cooling rate were both 10° C./min, and the sample was held isothermally for 10 min before each ramp. The second heating cycle was used for DSC analysis. TGA was conducted on TA Instruments TGA 5500 in a UHP nitrogen atmosphere with a sample purge rate of 25 mL/min and a balance purge rate of 10 mL/min. The sample was heated (20° C./min) to 120° C., cooled down (20° C./min) to 40° C., and heated up (10° C./min) again to 600° C. with an isothermal pause for 10 min before each temperature ramp. XRD was performed on a PANalytical X'Pert PRO MRD with nickel-filtered Cu Kα radiation source (λ=1.54 Å), divergence slit ¼°, anti-scatter slits ½°, 45 kV/40 mA, and 2θ=3-60° at room temperature. Tensile tests were performed on an Instron E3343 with a 20 mm/min extension rate. All samples were prepared using a dog-bone-shaped die (ASTM D1708). AFM was conducted on a Bruker MultiMode 8 using an ACSTA probe at room temperature. DMA was conducted on a Mettler Toledo Polymer-1 analyzer in tension mode in a temperature range of −80 to 200° C. at a heating rate of 3° C./min, a frequency of 1 Hz, and under 0.1% strain. The DMA measurements were done under dried nitrogen. SAXS was conducted using a CuKα radiation (λ=0.154 nm) source. Before the test, calibration of the sample-to-detector distance and beam centering was performed. The sample to detector distance was 2.54 m, and two-dimensional diffraction patterns were collected using a multivariate detector. Then, the patterns were converted to a one-dimensional figure. All X-ray scattering measurements were done at ambient temperature.

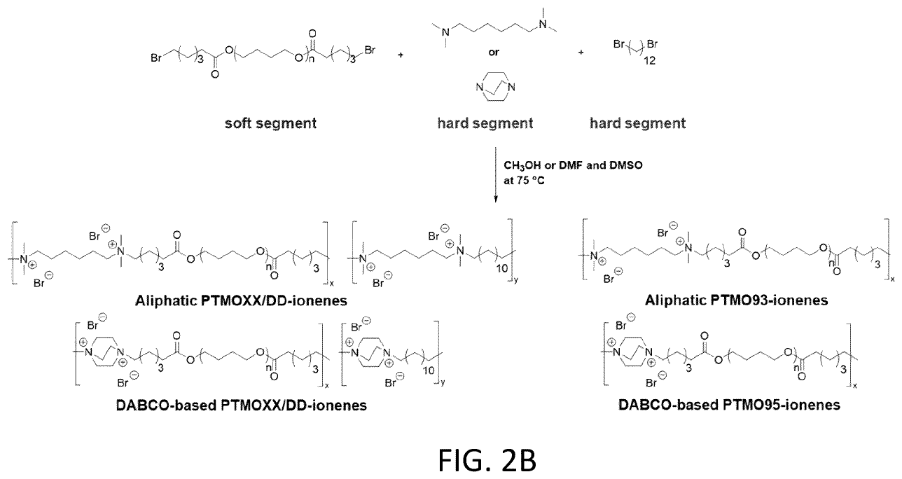

The desired linear aliphatic or DABCO-based PTMO-ionenes were synthesized via the Menshutkin reaction. FIG. 2A shows the synthesis of Br-PTMOₙ-Br. FIG. 2B shows the synthesis of linear aliphatic PTMOXX/DD-ionenes or DABCO-based PTMOXX/DD-ionenes. XX refers to 25, 50, or 75, which corresponds to the overall weight fraction of the PTMO soft segment. The Br-PTMOₙ-Br was used as a soft segment, which provides the material flexibility and softness. Two different hard segments, either a combination of 1,12-dibromododecane and N,N,N′,N′-tetramethyl-1,6-hexanediamine (linear aliphatic ammonium) or a combination of 1,12-dibromododecane and DABCO (heterocyclic aliphatic ammonium) were used, which provide material stiffness and mechanical behavior.

Br-PTMOₙ-Br was prepared by reacting PTMO-2k with a slight excess of 6-bromohexanoyl chloride in the presence of triethylamine to obtain the difunctional bromide end-capped monomer. The presence of the bromoalkyl functional group in PTMO oligomers was analyzed by ¹H NMR spectroscopy (the presence of the n, o, and m peaks and the ratio 0.97 of p to m confirmed the synthesis of Br-PTMOₙ-Br.

PTMO-based segmented ionenes with two different hard segments were successfully synthesized and confirmed by ¹H NMR spectroscopy, as shown in FIGS. 2A and 2B. The peaks from all samples were broadened after polymerization, which indicates a relatively higher molecular weight of the polymer. The shift of resonance at 2.2 and 2.6 ppm in the ¹H NMR spectrum attributed to methylene protons of N,N,N′, N′-tetramethyl-1,6-hexandiamine and DABCO, respectively, to 3.5 and 3.9 ppm, respectively, confirmed the quaternarization of the tertiary amines (arrows). Because of differences in solubility, the linear aliphatic PTMO ionenes (FIG. 2A) were analyzed in deutcrated chloroform, whereas the DABCO-based PTMO ionenes (FIG. 2B) were analyzed in deuterated DMSO. The differing polymer-solvent interactions contribute to the shifts in peak locations when comparing the two spectra.

All PTMO-based ionenes with linear aliphatic and DABCO hard segments made robust films regardless of the contents of soft/hard segments. Generally, the estimation of the molecular weight of ionenes is challenging if an appropriate GPC column is not available, due to the possible ionic interactions with the column, as well as the complicated solution conformation of ionenes. The absolute molecular weight of ionenes can be achieved with SEC that is coupled with multi-angle laser light scattering, but again this is dependent on the assumption of athermal solution conditions. The synthesis reaction time and solvent concentration were controlled precisely, and segmented ionenes were presumed to reach relatively high molecular weight by forming a decent elastomer. All samples were transparent, and DABCO-based PTMOXX/DD-ionenes created yellow-brown films as a final product, and DABCO-based PTMO95-ionenes had a faint yellow color. The mixture of DMF and DMSO was chosen as a polymerization solvent for the DABCO-based PTMOXX/DD-ionenes to achieve a higher molecular weight of segmented ionenes. The DABCO-based PTMOXX/DD-ionenes dissolve well in DMSO but are less soluble in DMF, whereas the monomers dissolve well in DMF. However, DABCO-based PTMO95-ionenes synthesized without 1,12-dibromododecane hard segment dissolved well in DMF. Therefore, it was suspected that the use of DMSO and, to a lesser extent, DMF was responsible at least in part for the color in the DABCO-based PTMOXX/DD-ionenes. Linear aliphatic and DABCO-based PTMOXX/DD-ionenes were re-cast in MeOH and DMSO, respectively, in a Teflon mold, and all samples had ˜0.5 mm thickness.

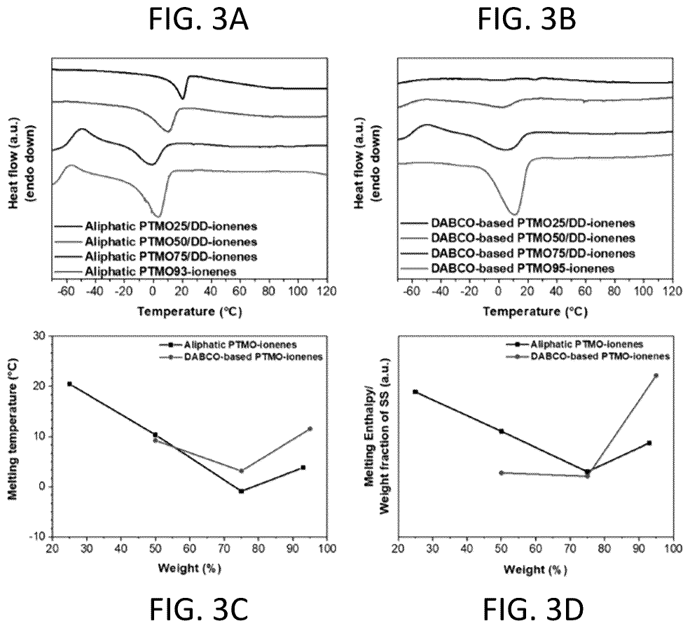

Thermal transitions of linear aliphatic or DABCO-based PTMO ionenes were studied by using DSC, as shown in FIGS. 3A-3D. All samples except DABCO-based 25/DD-ionenes, which had a negligible melting temperature, displayed a melting temperature lower than room temperature. Linear aliphatic and DABCO-based PTMO50/DD-ionenes and 75/DD-ionenes showed similar melting temperatures, which indicates a negligible effect of the structure of hard segment type on melting temperature of PTMOXX/DD-ionenes. The decrease of melting temperature with increasing the soft segment fractions up to 75 wt % was observed in both linear aliphatic and DABCO-based ionenes. This is possibly attributed to a decrease in the degree of crystallization of the PTMO soft segment. However, a further increase of the content of the soft segment over 75 wt % resulted in the increase of the melting temperature in which DABCO-based PTMO 95-ionene showed the highest melting temperature among DABCO-based PTMO ionenes. The heterocyclic aliphatic ammonium without dodecane hard segment provided better configurational freedom of PTMO soft segments to be crystallized than the linear aliphatic ammonium, and thus increased the melting temperature. The linear aliphatic PTMO93-ionene also showed an increase in the degree of crystallization by increasing the content of the soft segment from 75 wt % to 93 wt %; however, it was not significant compared to the DABCO hard segment. This revealed that alternating soft/hard segments might crystallize better than randomly distributed soft/hard segments regardless of the type of structure of hard segment, and the heterocyclic aliphatic structure (i.e., DABCO) induced better chain packing than linear aliphatic hard segment. Moreover, the incorporation of relatively long aliphatic hydrocarbons present in 1,12-dibromododecane and N,N,N′,N′-tetramethyl-1,6-hexanediamine hard segments possibly restricted chain mobility of PTMO-based ionenes. The absence of the dodecane hard segment induced a higher degree of crystallization of the PTMO soft segment of the DABCO-based PTMO95-ionene compared to the linear aliphatic PTMO93-ionene as shown in FIG. 3D. The melting peaks for both the linear aliphatic and DABCO-based PTMOXX/DD-ionenes broaden with an increasing content of the soft segment. It is suspected that increasing the PTMO soft segment content caused a heterogeneous size distribution of spherulites with both linear aliphatic and DABCO hard segments when dodecane was present. Ultimately, this caused loose chain packing and decreased the degree of crystallinity (Table S1). However, further increase in the content of the soft segment without the presence of dodecane hard segments (i.e., 93% and 95% samples) resulted in a more homogeneous size distribution of crystallites and caused the increase in the degree of crystallinity. The presence of the cold crystallization was observed with ionenes containing higher contents of PTMO soft segments, as indicated by an exotherm attributed to the rearrangement of the PTMO soft segment from a disordered state to a loose chain packing. For example, over 50 wt % and 25 wt % of the soft segment for PTMO-based ionenes with linear aliphatic and DABCO hard segments, respectively, showed the cold crystallization although it was not observed with DABCO-based PTMO95-ionenes.

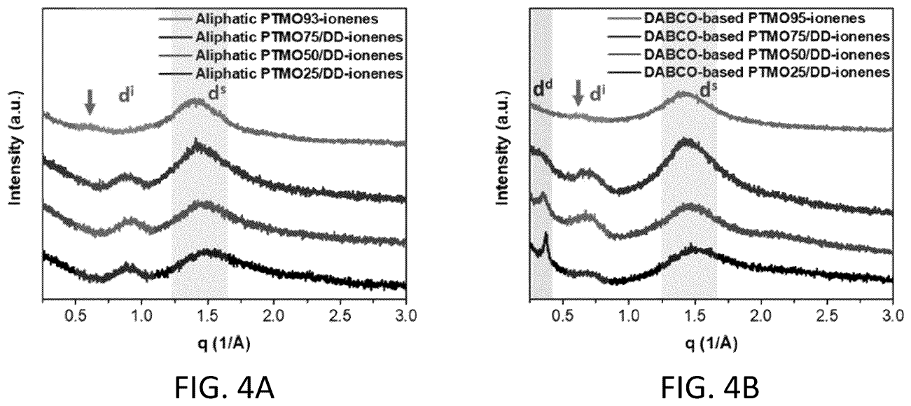

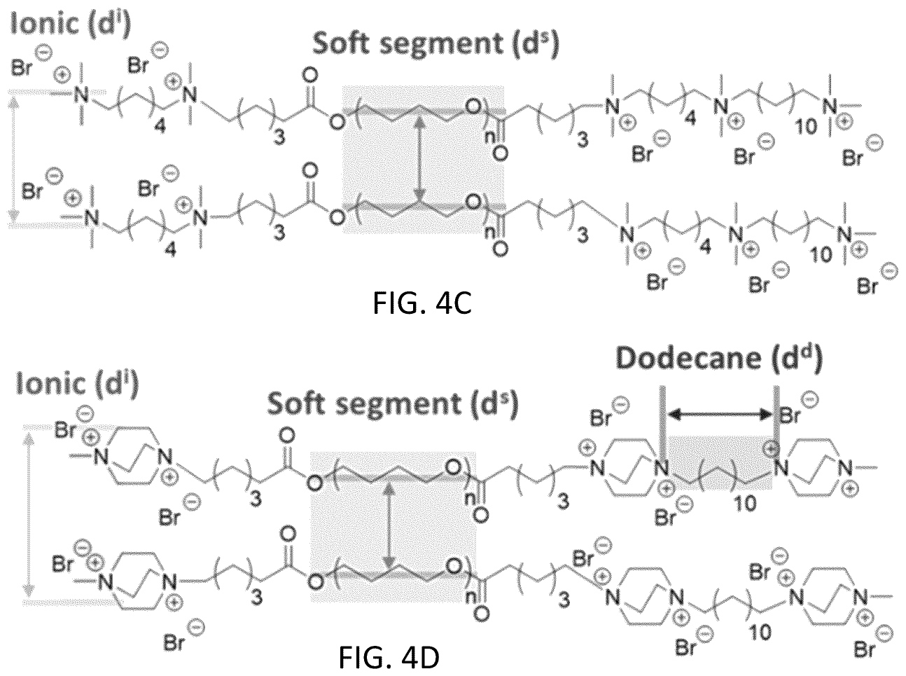

The local structure within the ionenes was confirmed with XRD. Because PTMO crystallites have a melting temperature below room temperature all of the PTMO-based ionenes were amorphous at room temperature, as shown in FIGS. 4A-4D. The Br-PTMOₙ-Br monomer showed two prominent sharp peaks (q=1.47 and 1.78 Å⁻¹) from the PTMO crystallites at room temperature; however, the PTMO soft segment of PTMO-based ionenes showed a broad amorphous halo. Two or three distinct peaks were observed for linear aliphatic versus DABCO-based PTMO-ionenes, respectively. The peaks below 0.5 Å⁻¹ were referred to as dodecane peaks (q^{d}), the peaks at 0.5-1 Å⁻¹ were referred to as ion-to-ion peaks (qⁱ), and peaks at 1-2 Å⁻¹ were attributed to PTMO-to-PTMO peaks (q^{s}). The idealized schematic of contributions to q^{d}, qⁱ, and q^{s} are shown in FIGS. 4C and 4D. The PTMO-based ionenes with soft segment fractions from 25 to 75 wt % showed two broad peaks (ca. q=0.91 Å⁻¹ (dⁱ=0.69 nm) and q=1.46 Å⁻¹ (d^{s}=0.43 nm) for linear aliphatic ionenes, and ca. q=0.68 Å⁻¹ (di=0.92 nm) and q=1.46 Å⁻¹ (ds=0.43 nm) for DABCO-based ionenes) as shown in Table 2.

Table 2. Characteristic dimensions of the soft and hard domains, and thermal stability as determined by XRD, SAXS, and TGA. Superscripts d (dodecane), i (ionic), and s (soft segment) correspond to blue, yellow, and green shades in the XRD data, respectively, shown in FIGS. 4A-4B.

| | | |
|---|---|---|
| SAXS | XRD | TGA |

| Sample | [symbol] | [symbol] | [symbol] | [symbol] | [symbol] | [symbol] | [symbol] | [symbol] |
|---|---|---|---|---|---|---|---|---|
| [symbol] | [symbol] | [symbol] | — | [symbol] | [symbol] | [symbol] | [symbol] | [symbol] |
| [symbol] | [symbol] | [symbol] | — | [symbol] | [symbol] | [symbol] | [symbol] | [symbol] |
| [symbol] | [symbol] | [symbol] | — | [symbol] | [symbol] | [symbol] | [symbol] | [symbol] |
| [symbol] | [symbol] | [symbol] | — | [symbol] | [symbol] | [symbol] | [symbol] | [symbol] |
| [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] |
| [symbol] | [symbol] | [symbol] | — | [symbol] | [symbol] | [symbol] | [symbol] | [symbol] |

[symbol]

indicates data missing or illegible when filed

Characteristic dimensions of the soft and hard domains, and thermal stability as determined by XRD, SAXS, and TGA. Superscripts d (dodecane), i (ionic), and s (soft segment) correspond to shaded regions in the XRD data, respectively, shown in FIGS. 4A-4B.

The highest soft segment fractions showed slightly different behavior with peaks at ca. 0.62 Å⁻¹ (dⁱ=1.01 nm) and 1.41 Å⁻¹ (d^{s}=0.44 nm) for both lincar aliphatic PTMO93 and DABCO-based PTMO95-ionenes. The linear aliphatic PTMO ionenes with soft segment fractions from 25 to 75 wt % showed a higher value of di compared to DABCO-based ionenes possibly due to the rigid heterocyclic structure of DABCO. DABCO-based PTMOXX/DD-ionenes showed an additional peak at ca. q=0.37 Å⁻¹ (dd=1.69 nm), presenting the periodicity between DABCO units when the dodecane hard segments were introduced. DABCO-based PTMO95-ionenes exhibited no diffraction peak in this region due at least in part to the absence of dodecane hard segments (spacer), however; the peak became narrower with increasing dodecane fractions. Linear aliphatic PTMOXX/DD-ionenes did not show d^{d} due to two possible reasons: i) linear aliphatic-dodecane chains are more randomly distributed compared to DABCO-dodecane chains, or ii) linear aliphatic hard segment has a lower electron density contrast compared to DABCO hard segment. A combination of the two is probable since the DABCO ion has less conformational freedom; therefore, a more uniform periodicity of groups with a higher electron density relative to the polymer matrix would produce the scattering peak observed. The d-spacing in the amorphous halo from the PTMO soft segments, d^{s}, were similar regardless of the type of hard segment and the presence of the spacer.

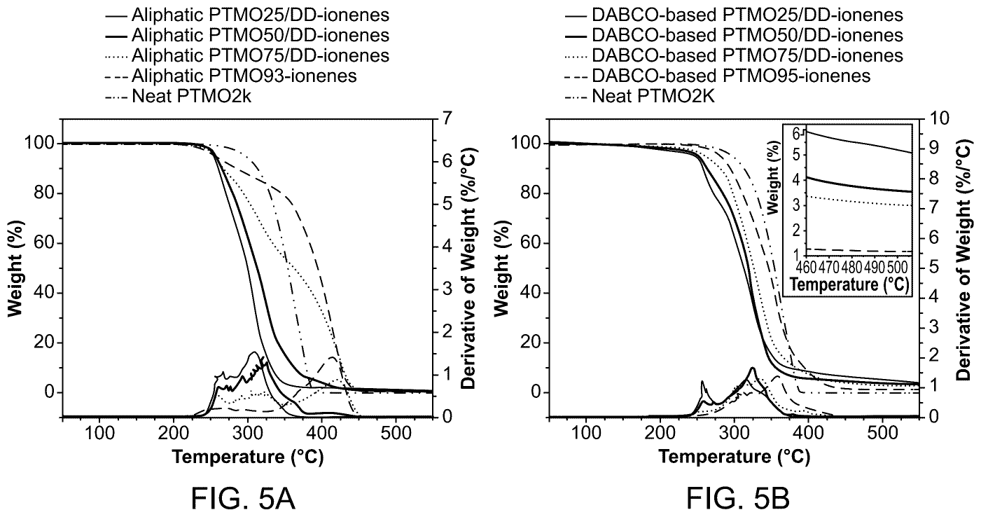

The thermal stability of PTMO-based ionenes was studied using TGA under a nitrogen atmosphere, as shown in FIGS. 5A and 5B. The thermal stability depends at least in part on the content of the soft segment, mutual interaction between degradation of soft/hard segment, and degree of phase separation. Linear aliphatic and DABCO-based PTMO-ionenes showed thermal stability (T_{d5%}) up to ca. 250° C., and DABCO-based PTMO-ionenes showed a clear gradual increase of thermal stability from 247° C. to 281° C. by increasing the content of the soft segment from 25 to 95 wt % (Table 2). Linear aliphatic PTMO-ionenes showed slightly higher thermal stability with higher content of soft segment compared to 25 wt %; however, it was not significant. The PTMO-based ionenes possessing higher amounts of DABCO hard segments showed higher char residue at ca. 500° C. compared to linear aliphatic ionenes, as shown in FIG. 5B. Ionenes and other molecules containing quaternary ammoniums have similar degradation pathways including nucleophilic substitution and/or Hoffman elimination reaction, which, in the case of ionenes, are dependent on the counterion present in the hard segment. The two-step weight loss of all ionenes is shown in the derivative of the weight curve. The first weight loss corresponded to the hard segment, and the value of the derivative of weight increased with decreasing the soft segment content. The linear aliphatic ionenes with over 50 wt % of PTMO soft segment clearly showed a different degradation trend than DABCO-based ionenes analogs against neat PTMO2k. The linear aliphatic ionenes exceeded the degradation temperature of neat PTMO2k with over 50 wt % of PTMO soft segment at elevated temperatures (ca. 400° C.). This suggests that DABCO has a weaker protective effect against the degradation of PTMO soft segments compared to the linear aliphatic hard segment.

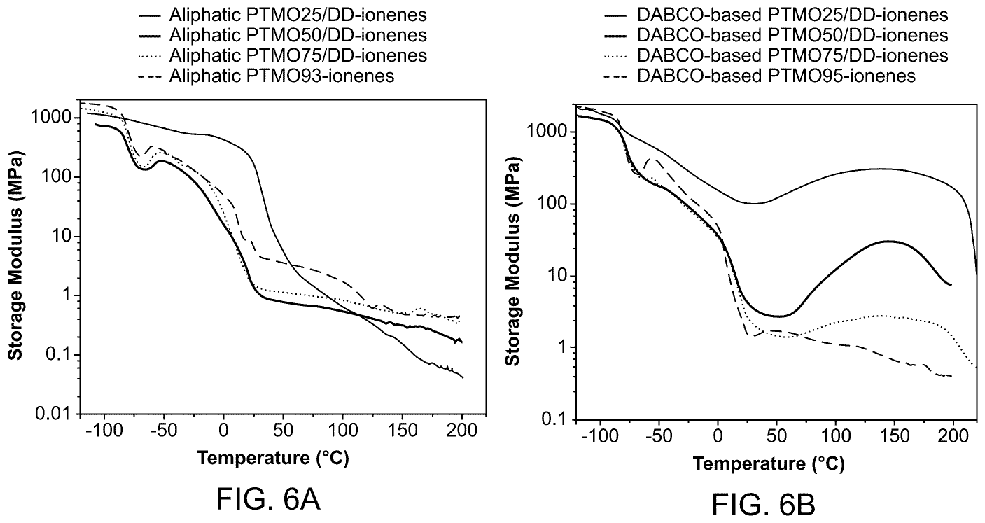

The viscoelastic properties of PTMO-based ionenes were analyzed using DMA. The first transition is attributed to the segmental motions of PTMO soft segments, and as can be seen in FIGS. 6A and 6B, the T_{g} value is ca. −70° C. for all samples regardless of the hard segment type and this value is within the range of the T_{g} of pure PTMO. This revealed the presence of phase separation in the PTMO-based ionenes regardless of the type of hard segments. At the end of the glass transition region, a cold crystallization occurred in linear aliphatic and DABCO-based ionenes for soft segments over 25 wt % and 50 wt %, respectively, which was observed with the DSC data. However, the inconsistency between DSC and DMA results of the weight fraction at which the cold crystallization appears is likely due to the different thermal history of PTMO-based ionenes. The presence of higher amounts of crystallites in the samples by reducing the spacer content was reflected in an increase of the glassy modulus.

The third transition describes the melting temperature of PTMO crystallites that caused a significant decrease in storage modulus. The DABCO-based PTMO25/DD-ionene showed the most negligible loss of storage modulus among all PTMO-based ionenes due to the absence of crystallization and the presence of ionic domains. The rubbery plateau was observed for DABCO-based PTMOXX/DD-ionenes, and the DABCO-based PTMO25/DD-ionene showed the broadest plateau as well as the highest rubbery plateau storage modulus among the samples due to the high charge density and ionic aggregation. The physical cross-linking effect was notable in DABCO-based PTMO25/DD-ionene compared to its linear aliphatic counterpart, according to a higher value of its plateau modulus (i.e., 100 MPa). This also suggested that DABCO-based PTMO25/DD-ionene had a higher degree of microphase separation. An overshoot occurred in the storage modulus of DABCO-based PTMO50/DD-ionenes after the melting of crystallites. This can be due to the chain packing of hard segments after rearrangement of the structure that changed the conformation of ionic domains.

The fourth transition occurred following ion dissociation and the onset of viscous flow in the PTMO-based ionenes. The linear aliphatic PTMO ionenes showed a weak fourth transition due to the weak ionic aggregation at temperatures between 125 and 175° C. compared to DABCO-based ionenes, which flowed at higher temperatures between 150 and 220° C. The DABCO-based PTMO25/DD-ionene showed the highest ion dissociation temperature (˜215° C.) due at least in part to the highest content of hard segment and the nature of higher positive charge density and better proximity of charged sites, which appeared as a significant increase in tan delta curve due to the softening of higher fraction of DABCO hard segments.

SAXS experiments can be used to investigate the microstructure of segmented block polymers based on the electron density difference between the different domains. The covalent bond between the soft and hard segments prevents macrophase separation, but, still, due to different chemical components the two blocks formed segregated structures. Therefore, periodic microphase separation happens in the nanometer scale (1-100 nm). The Bragg spacing (d, or interdomain spacing) can be calculated using the value of the scattering vector (q) according to the following equation, where q1 is the value of the scattering vector at the maximum of the first peak (d=2π/q1).

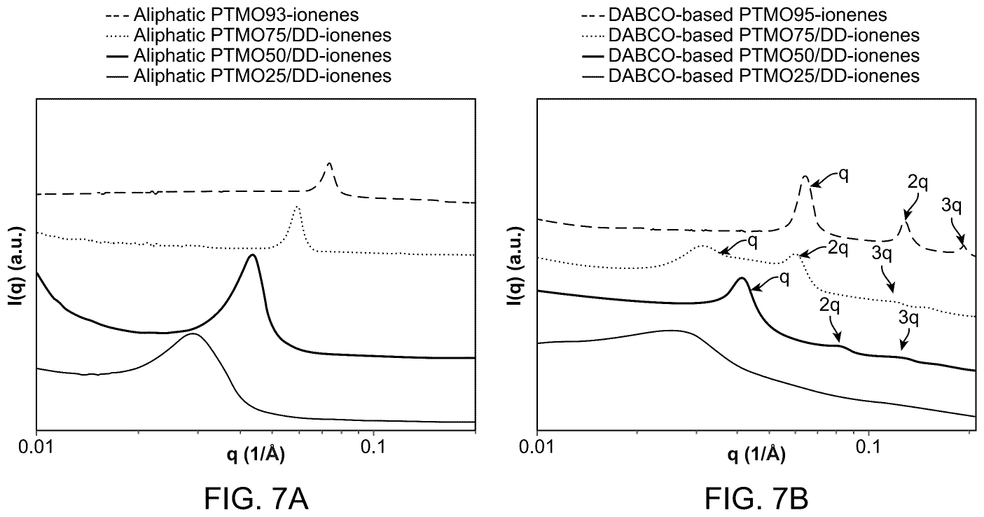

The higher fraction of ionic hard segments increases the strength of Coulombic interactions and results in PTMO chain stretching between the ionic hard segments. The decrease of q values as the content of the hard segment increases indicated an increase in the spacing of hard domains (an increase of microdomain spacing) by stretching the PTMO chains (FIGS. 7A and 7B). Indeed, the largest d-spacing values (interdomain spacing) were observed for linear aliphatic and DABCO-based PTMO25/DD-ionenes at 21.66 nm and 25.31 nm, respectively (Table 2). Moreover, both PTMO-based ionenes with 25 wt % of soft segment showed the broadest peak among other fractions, resulting from the existence of a distribution of spacings attributed to the possible different degrees of the ordering. The polymers synthesized without any dibromododecane (i.e., linear aliphatic PTMO93 and DABCO-based PTMO95-ionenes) decreased the d-spacing to 8.6 nm (single broad peak) and 9.8 nm (lamellar morphology) for linear aliphatic PTMO93 and DABCO-based PTMO95-ionenes, respectively.

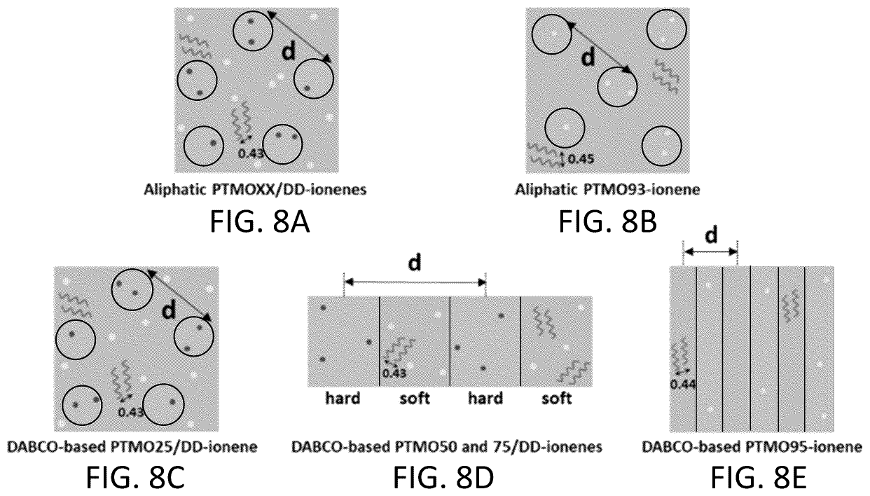

The observation of a single and broad X-ray scattering peak is attributed to a spherical aggregation of ionic segments and a poorly ordered structure in the SAXS profiles of the linear aliphatic PTMO ionenes. In contrast, a sharp primary scattering peak accompanied by multiple scattering peaks for the DABCO-based ionenes indicates the existence of an ordered structure. Differing morphologies between DABCO-based and linear aliphatic ionenes could be due to the architectural difference of hard segments. The position of scattering maximums for DABCO-based PTMO ionenes with over 25 wt % of soft segment appeared at the ratio of 1:2:3 (i.e., q:2q:3q in FIG. 7B) that represents the formation of microphase separated lamellar structure. The intensity of the second-order peak decreases significantly in the case of DABCO-based PTMO50/DD-ionenes, suggesting a combination of lamellar structure and spherical ionic aggregates, while a fairly high intensity for the second and third-order peaks of DABCO-based PTMO95-ionenes showed an ordered lamellar structure. This presents the possibility that DABCO-based PTMO75/DD-ionenes formed ordered lamellar structure with disc-like ionic aggregation. The proposed morphology of all PTMO-based ionenes based on X-ray scattering results are shown in FIGS. 8A-8E.

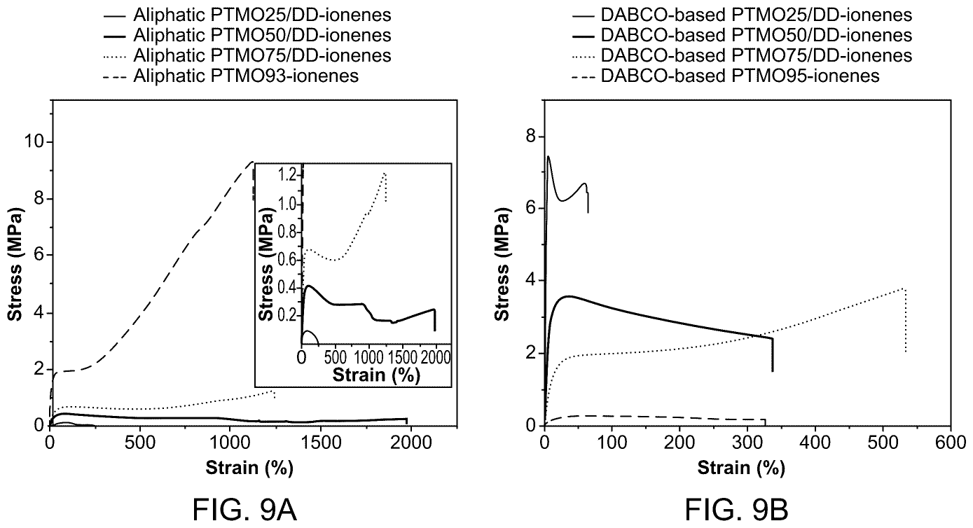

Uniaxial tensile tests were performed at room temperature with both linear aliphatic and DABCO-based ionenes, as shown in FIGS. 9A and 9B. PTMO-based ionenes with a linear aliphatic hard segment showed higher elongation than DABCO analogs (Table 3). The linear aliphatic PTMO50/DD-ionene showed the most promising elongation, ca. 2070%, among all the PTMO-based ionenes; however, increasing the content of the soft segment over 50 wt % decreased the elongation due to the stress-induced crystallization. It revealed that the stress-induced crystallization occurs effectively with over 50 wt % of PTMO soft segment, which caused an upturn in the stress-strain curve and provided high stress at break. This effect was significant for the linear aliphatic hard segment compared to the DABCO hard segment. The linear aliphatic PTMO93-ionene, PTMO75/DD-ionene, and DABCO-based PTMO75/DD-ionene displayed significant stress-induced crystallization of PTMO soft segment beginning at strains of ca. 100%, 500%, and 200%, respectively. The 25 and 50 wt % of PTMO (molecular weight 2000 g mol⁻¹) soft segment may not provide long enough soft segment to induce stress-induced crystallization.

Table 3. Tensile stress-strain data for linear aliphatic and DABCO-based PTMO ionenes at room temperature.

| | | Ultimate | Tensile | |
|---|---|---|---|---|
| | Young's | tensile | strain at | |
| | Modulus | strength | break | Toughness |
| Sample | (MPa) | (MPa) | (%) | (MPa) |
| Aliphatic | 0.444 ± | 0.098 ± | 261.34 ± | 0.169 ± |
| PTMO25/ | 0.070 | 0.005 | 22.64 | 0.015 |
| DD-ionenes | | | | |
| Aliphatic | 1.249 ± | 0.392 ± | 2070.45 ± | 5.302 ± |
| PTMO50/ | 0.128 | 0.082 | 137.98 | 0.464 |
| DD-ionenes | | | | |
| Aliphatic | 2.042 ± | 1.539 ± | 1414.58 ± | 11.841 ± |
| PTMO75/ | 0.202 | 0.403 | 150.59 | 2.566 |
| DD-ionenes | | | | |
| Aliphatic | 12.507 ± | 8.901 ± | 1140.8 ± | 53.653 ± |
| PTMO93- | 1.160 | 0.808 | 196.52 | 11.408 |
| ionenes | | | | |
| DABCO-based | 231.469 ± | 7.828 ± | 63.051 ± | 4.28 ± |
| PTMO25/ | 8.856 | 0.477 | 6.265 | 0.278 |
| DD-ionenes | | | | |
| DABCO-based | 43.065 ± | 4.637 ± | 335.66 ± | 11.806 ± |
| PTMO50/ | 12.874 | 2.462 | 109.63 | 4.299 |
| DD-ionenes | | | | |
| DABCO-based | 10.157 ± | 3.717 ± | 509.411 ± | 13.218 ± |
| PTMO75/ | 0.935 | 1.028 | 179.69 | 6.246 |
| DD-ionenes | | | | |
| DABCO-based | 1.059 ± | 0.287 ± | 308.438 ± | 0.743 ± |
| PTMO95- | 0.078 | 0.025 | 50.42 | 0.031 |
| ionenes | | | | |

DABCO-based PTMOXX/DD-ionenes showed higher toughness compared to the corresponding linear aliphatic ionenes. The shorter hard segment chains extend first and cause a rapid stress increase. The relatively short-chain and rigid heterocyclic structure of the DABCO hard segment induced a higher Young's modulus compared to the linear aliphatic hard segment. Young's modulus and ultimate tensile strength increased with decreasing soft segment content for DABCO-based ionenes due to the higher hard segment content, hence promoting better ionic aggregation. However, PTMO-based ionenes with lincar aliphatic hard segments showed the opposite trend with increasing the hard segment content. This is possibly due to morphological differences, which will be further discussed below. The lincar aliphatic PTMO93-ionene showed prominent stress-induced crystallization with high mechanical strength due to the high content of the soft segment, amorphous structure, and less degree of crystallization compared to the DABCO-based PTMO95-ionene, as shown by the DSC and XRD results (FIGS. 3A-3D and 4A-4B). DABCO-based ionenes snapped back to approximately their unstressed length after the break compared to the linear aliphatic ionenes, which implied that DABCO-based ionenes possessed higher cohesive ionic aggregates compared to linear aliphatic ionenes.

The morphology of the linear aliphatic and DABCO-based PTMO ionenes was analyzed by using AFM at room temperature, as shown in FIGS. 10A-10H. The darker and brighter regions corresponded to the soft and ionic hard segments, respectively. DABCO-based ionenes with over 25 wt % of soft segments showed a relatively ordered lamellar structure compared to counterparts of linear aliphatic ionenes, which corroborated the SAXS results. All PTMO-based ionenes showed significant microphase separation regardless of the type of the hard segment. The linear aliphatic ionenes showed more interconnected hard domains with increasing soft segment content, whereas DABCO-based ionene hard segments were more isolated, at least on the film surface, as the soft segment content increased. The opposite trend of morphology between linear aliphatic PTMO-ionenes and DABCO-based ionenes confirmed the trend of tensile test results (Table 3) that linear aliphatic ionenes had lower Young's modulus and ultimate tensile strength with decreasing the soft segment content. As previously shown in SAXS results, DABCO-based PTMO50/DD-ionenes, PTMO75/DD-ionenes, and PTMO95-ionenes showed lamellar morphology, and it was more significant with increasing the content of the soft segment.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A method of synthesizing an ionene polymer, the method comprising:
combining a soft segment, a hard segment, and a solvent to yield a mixture;
heating the mixture to yield the ionene polymer,
wherein the soft segment comprises bromine end-capped PTMOₙ (Br-PTMOₙ-Br), and the hard segment comprises a linear aliphatic compound or 1,4-diazabicyclo[2.2.2]octane (DABCO).

2. The method of claim 1, wherein a molar ratio of the soft segment to the hard segment is about 1.

3. The method of claim 1, wherein the hard segment comprises the linear aliphatic compound.

4. The method of claim 3, wherein the linear aliphatic compound is tetramethyl-1,6-hexanediamine.

5. The method of claim 4, wherein the solvent is a polar organic solvent.

6. The method of claim 5, wherein the polar organic solvent comprises methanol, N-methyl-2-pyrrolidone, dimethylglyoxime, dimethylacetamide, ethanol, acetone, dimethyl sulfoxide, or a combination thereof.

7. The method of claim 5, wherein the ionene polymer is represented by: 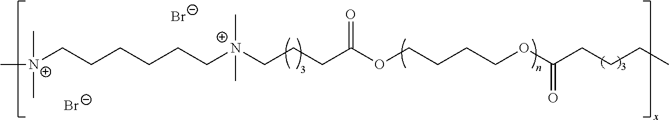
where n and x are integers.

8. The method of claim 1, wherein the hard segment comprises the DABCO.

9. The method of claim 8, wherein the solvent comprises methanol, N-methyl-2-pyrrolidone, dimethylglyoxime, dimethylacetamide, ethanol, acetone, or dimethyl sulfoxide, or a combination thereof.

10. The method of claim 8, wherein the ionene polymer is represented by: 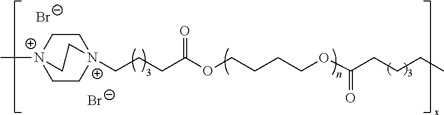
where n and x are integers.

11. The method of claim 1, wherein the hard segment further comprises an additional linear aliphatic compound.

12. The method of claim 11, wherein the additional linear aliphatic compound comprises 1,12-dibromododecane.

13. The method of claim 11, wherein the hard segment comprises the linear aliphatic compound.

14. The method of claim 13, wherein the linear aliphatic compound is tetramethyl-1,6-hexanediamine.

15. The method of claim 13, wherein the weight fraction of the soft segment is in a range of 0.1 to 0.9 or 0.25 to 0.75.

16. The method of claim 13, wherein the solvent comprises methanol, N-methyl-2-pyrrolidone, dimethylglyoxime, dimethylacetamide, ethanol, acetone, or dimethyl sulfoxide, or a combination thereof.

17. The method of claim 16, wherein the ionene polymer is represented by: 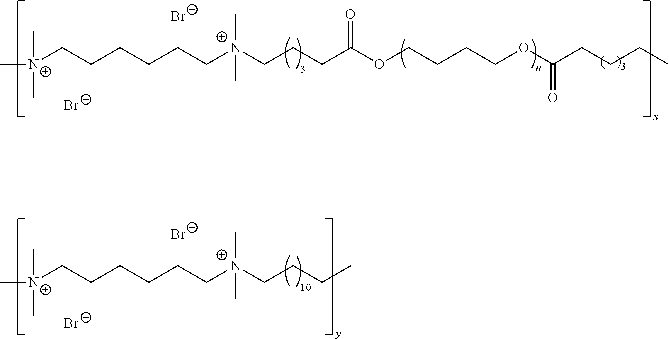
where n, x, and y are integers.

18. The method of claim 11, wherein the hard segment comprises the DABCO.

19. The method of claim 18, wherein the solvent comprises methanol, N-methyl-2-pyrrolidone, dimethylglyoxime, dimethylacetamide, ethanol, acetone, or dimethyl sulfoxide, or a combination thereof.

20. The method of claim 19, wherein the ionene polymer is represented by: 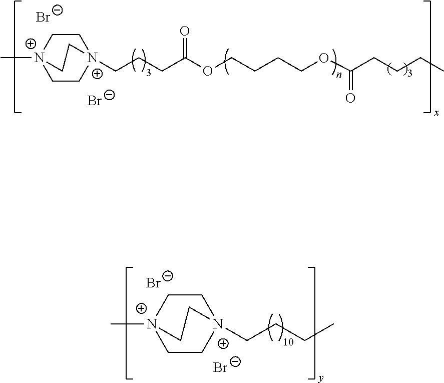
where n, x, and y are integers.

21. The ionene polymer of claim 1.
